(19) United States
(12) Patent Application Publication
(10) Pub. No.: US 2005/0154675 A1
(43) Pub. Date: Jul. 14, 2005

(54) An Internet System for Speedy Delivery of a Greeting Card and Gift

(76) Inventor: Michael L Johnson Jr., Yorktown Heights, NY (US)

Correspondence Address: JEFFREY FURR, 253 N. MAIN STREET, JOHNSTOWN, OH, 43031, US

(21) Appl. No.: 10/707,798

(22) Filed: Jan. 13, 2004

(51) Int. Cl. G06F 17/60; G06F 17/00

(52) U.S. Cl. 705/44; 705/45; 705/26; 705/400

(57) ABSTRACT

The current invention is a greeting cards Internet service. It is a method and process that is an electronic greeting card service that utilizes the distributed access afforded by the Internet or local area networks (LANs) to enable the sending of a greeting card or cards with a cashier's check as a gift in a single order.

### BACKGROUND OF INVENTION

1. Field of the Invention

This invention relates to the art of sending greeting cards and a monetary gift, specifically to the use of the Internet and a web site for this purpose.

2. Description of Prior Art

With the new E-World with E-commerce and E-greetings there is a need for an easy, inexpensive, and convenient method for multiple people to electronically sign and send an electronic greeting and gift. There are many services such as American Greetings that allow the sending of electronic greeting cards.

In the current art, if it's three days before someone's favorite uncle's birthday and they forgot to mail his birthday card or their favorite niece is graduating from college this coming weekend there are few options. Someone can panic. They could run out to the local store at 10 pm to find and purchase a card. Then they must, after returning home, write a message that's pleasant and joyful, write a check to give them something they really will appreciate, seal the card in the envelope, search for a stamp and hope the mailman takes it away the next day.

The World Wide Web is currently a subject of intense and rapidly growing interest. The World Wide Web is composed of interconnected data sources that are accessible to computer users through data-communication networks such as the Internet. The data available on the World Wide Web has been assembled by private individuals, commercial companies, government agencies, and special interest organizations. Much of this assembled information is organized into Web pages. A Web site is a collection of Web pages (and possibly other data which, together with Web pages, are generically referred to as Web components) offered by a sponsoring entity, herein referred to as the site owner.

Large Web sites are typically organized hierarchically. For example, corporate Web sites often consist of smaller Web sites, each providing information about a business unit of the parent company.

The Web site itself resides on one or more server hosts. Web components stored on the server host are offered to users of the World Wide Web through a software program known as a Web server. A network user uploads or downloads data from a Web site through a browser, a software program running on the client host. The browser establishes contact with the Web server and issues a request for data stored on the server host. This results in data from the server host being downloaded into the browser. This data is typically a HyperText document specifying information required by the browser to display the Web page (i.e., formatting information specifying the structure of the page, or URLs of images that are to be placed on the page), embedded client software programs which run inside the browser (e.g., Java bytecode), and other content to be downloaded to the client computer or displayable through client software programs that add to the browser's functionality (sometimes referred to as “browser plug-ins”).

Currently, Web pages are typically defined using HyperText Markup Language (“HTML”). HTML provides a standard set of tags that define how a Web page is to be displayed. When a user indicates to the browser to display a Web page, the browser sends a request to the server computer system to transfer to the client computer system an HTML document that defines the Web page. When the requested HTML document is received by the client computer system, the browser displays the Web page as defined by the HTML document. The HTML document contains various tags that control the displaying of text, graphics, controls, and other features. The HTML document may contain URLs of other Web pages available on that server computer system or other server computer systems.

With the rapid growth of computer networking and requests for information from one computer to the next e.g. the Internet, it has become common practice for a provider of information (a “Server”) to provide each specific requester of information (a “Client”), with an electronic “token” (commonly referred to as a “Cookie”) for the purpose of “recognizing” the client and/or providing some pre-determined and pre-programmed level of customization at the discretion of the information provider.

### PRIOR ART

U.S. Pat. No. 6,574,604 by van Rijn and issued on Jun. 3, 2003 is for an “Internet message system.” It discloses an internet message system that enables a user to compose an electronic greeting message and transmit the greeting message to any e-mail address over the Internet from a remote location. The internet message system is housed within a self-contained unit, such as a kiosk, such that it can be situated within various recreational and vacation locations.

U.S. Pat. No. 6,466,830 by Manross, et al. and issued on Oct. 15, 2002 is for an “Apparatus and method for producing electronic messages in a vending terminal.” It discloses an interactive internet photo terminal for composing an electronic self-image photo message utilizing a “live” image background of the terminal's location. The photo terminal includes a cash and credit receiving device, video camera and message composition input control monitor interconnected to a CPU and telecommunication connector capability.

U.S. Pat. No. 6,295,058 by Hsu, et al. and issued on Sep. 25, 2001 is for a “Method and apparatus for creating multimedia electronic mail messages or greeting cards on an interactive receiver.” It discloses a system where a user composes a multimedia greeting card or multimedia email message by selecting a design template, which has previously been created and stored on the system. The design template contains one or more slots, into which the user may simply drag and drop any desired text, video, or audio data. The user may also edit and add enhancements to the multimedia greeting card or email message.

U.S. Pat. No. 6,076,076 by Gottfreid and issued on Jun. 13, 2000 is for a “Prepaid print card system and method.” It discloses prepaid printing services which are obtained, and provided using remote and host computers. A card or diskette for printing services is purchased and using a remote computer, the host computer is accessed by e-mail or the like. Application software and printer drivers are downloaded from the host to the remote and the prepaid printing services are actually installed as a print option on the print menu of the remote computer. Document composition and printing to fulfill the printing services request can be by any conventional technique, and debiting and invoicing are typically practiced simultaneously with document shipment.

U.S. Pat. No. 5,748,484 by Cannon, et al. and issued on May 5, 1998 is for a “System for printing social expression cards in response to electronically transmitted orders.” It discloses a system for viewing, ordering, and printing social expression cards, including a database preparation system, a number of card display/order systems, and a number of card printing systems.

U.S. Pat. No. 5,555,496 by Tackbary, et al. and published on Sep. 10, 1996 is for a “Method and apparatus for communicating with a card distribution center for management, selection, and delivery of social expression cards.” It discloses a system for communicating with a card distribution center for selecting, ordering, and sending social expression cards using a personal computer. The user can enter names and addresses of card recipients into the system wherein the information is maintained in a database. The system displays digitized images of the cards on a display screen which are retrieved from a card database. From the cards displayed, the user can select cards for designated recipients and enter personalized messages and a digitized signature. The user may then send the order to a card distribution center, which processes the order, retrieves and prints the selected card images, including any user messages or user signature, and mails the cards to designated recipients or customers. The system maintains a database of all recipients, addresses, associated occasions and dates, card preferences, relationships and order history.

The needs for a better method for the sending of greeting cards, that is faster, inexpensive, and easy to use shows that there is still room for improvement within the art.

### SUMMARY OF INVENTION

The object of the present invention is to provide a method to send greeting cards that is fast, easy, inexpensive, and convenient.

The current invention is a greeting cards” Internet service.

More particularly, the present invention relates to the sending of a greeting card, and potentially a monetary gift that utilizes the distributed access afforded by the Internet or local area networks (LANs) to enable the selection and sending of a greeting card and its delivery to a recipient.

The current invention utilizes the Internet. The Internet comprises a vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical Web pages of information to a remote client computer system. The remote client computer system can then display the Web pages. Each resource (e.g., computer or Web page) of the WWW is uniquely identifiable by a Uniform Resource Locator (“URL”). To view a specific Web page, a client computer system specifies the URL for that Web page in a request (e.g., a HyperText Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that affects the requesting of Web pages and the displaying of Web pages.

The process is more efficient, effective, accurate and functional than the current art.

Glossary of Terms

Browser: a software program that runs on a client host and is used to request Web pages and other data from server hosts. This data can be downloaded to the client's disk or displayed on the screen by the browser.

Client host: a computer that requests Web pages from server hosts, and generally communicates through a browser program.

Content provider: a person responsible for providing the information that makes up a collection of Web pages.

Embedded client software programs: software programs that comprise part of a Web site and that get downloaded into, and executed by, the browser.

Clip: a video stream that contains images and possible sound.

Cookies: data blocks that are transmitted to a client browser by a web site.

Hit: the event of a browser requesting a single Web component.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages. In its raw form, HTML looks like normal text, interspersed with formatting commands. A browser's primary function is to read and render HTML.

HTTP (HyperText Transfer Protocol): protocol used between a browser and a Web server to exchange Web pages and other data over the Internet.

HyperText: text annotated with links to other Web pages (e.g., HTML).

IP (Internet Protocol): the communication protocol governing the Internet.

Logfile: a file residing on the Web site in which the Web server logs information about browsers requesting Web components. The logfile typically contains one line per hit.

Pageview: the event of a browser downloading some or all of the Web components that make up a Web page and displaying the Web page. A pageview often consists of several hits.

Referral page: the URL of the Web page containing the HyperText link that led a visitor to the data currently being viewed. In most commercial browsers, the BACK button returns the visitor to this referral page.

Server host: a computer on the Internet that hands out Web pages through a Web server program.

Uploader: someone who wants to upload a video clip or image.

URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.

UWU server: in connection with the present invention, a special Web server in charge of distributing statistics describing Web traffic.

Viewer: someone who wants to view the video image or clip.

Visit: a series of requests to a fixed Web server by a single person (through a browser), occurring contiguously in time.

Visitor: a person operating a browser and, through it, visiting a Web site.

Web component: a basic data building block that makes up a Web page. A Web component may contain text, HyperText, images, embedded client software programs, or other data displayable by a browser (such as, for example, QuickTime videos).

Web designer: a person, typically one skilled in graphical design, who has charge of designing Web pages.

Web master: the (typically, technically trained) person in charge of keeping a host server and Web server program running.

Web page: multimedia information on a Web site. A Web page is typically an HTML document comprising other Web components, such as images.

Web server: a software program running on a server host, for handing out Web pages.

Web site: a collection of Web pages residing on one or multiple server hosts and accessible through the same hostname (such as, for example, www.lucent.com).

### BRIEF DESCRIPTION OF DRAWINGS

Without restricting the full scope of this invention, the preferred form of this invention is illustrated in the following drawings:

FIG. 1 shows an overview of how a User accesses the system through the Internet;

FIG. 2 shows the system main web page;

FIG. 3 shows how a user selects a card to send;

FIG. 4 displays a card customize screen;

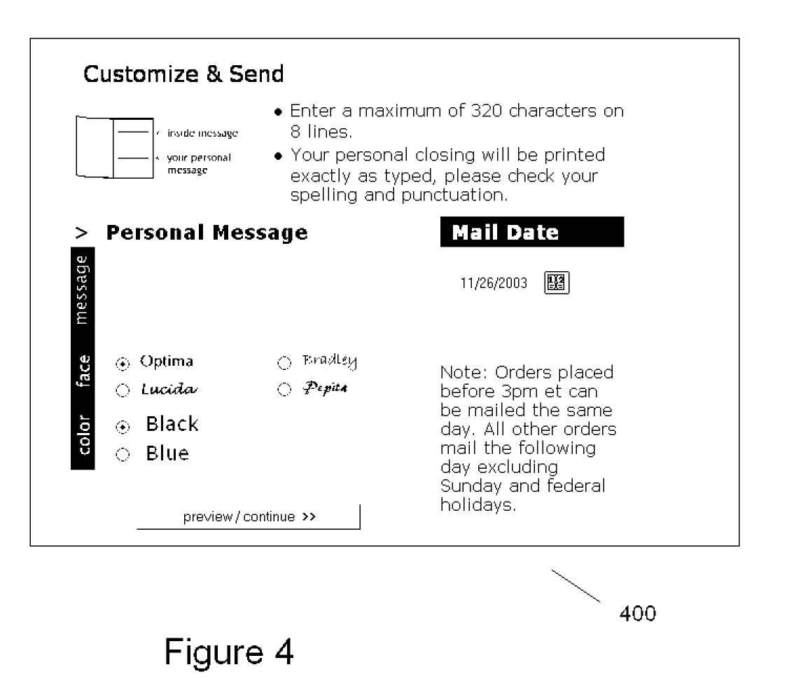

FIG. 5 displays a flowchart of the process; and

FIG. 6 displays how a card goes through the process.

### DETAILED DESCRIPTION

The current invention is a system and method for having someone select, sign and send a greeting card to a recipient as well as allowing the user to send a monetary gift.

This system 1 will allow a user 10 to: Point and click to find the desired card, write a personal message and “sign” the card, review what the card will look like, may include a monetary payment such as an EZcheck or money orders for cash, enter the delivery and billing information and place the order and receive status in real time. This process often takes less than 5 minutes.

The current invention utilizes the Internet. The Internet comprises a vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical Web pages of information to a remote client computer system. The remote client computer system can then display the Web pages. Each resource (e.g., computer or Web page) of the WWW is uniquely identifiable by a Uniform Resource Locator (“URL”). To view a specific Web page, a client computer system specifies the URL for that Web page in a request (e.g., a HyperText Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that affects the requesting of Web pages and the displaying of Web pages.

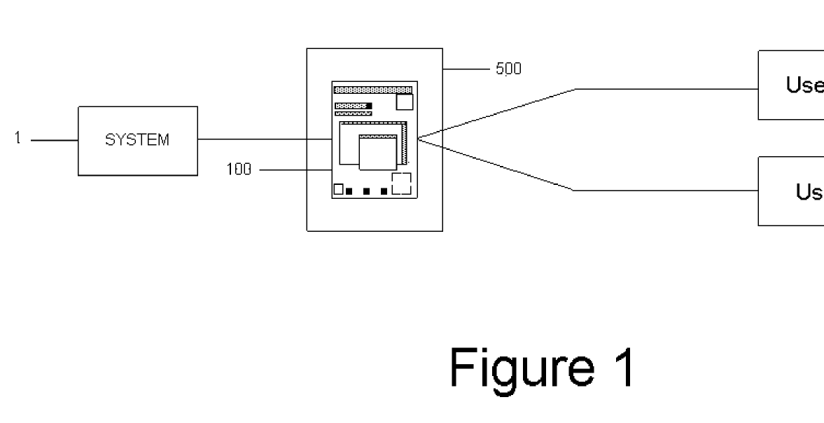

FIG. 1 illustrates a functional diagram of a computer network for World Wide Web access to the system 1 from a plurality of Users 10 to the web site 100. Accessing the web site 100 can be accomplished directly through a communication means such as a local Internet Service Provider, often referred to as ISPs, or through an on-line service provider like CompuServe, Prodigy, American Online, etc.

The Users 10 contact the web site 100 using an informational processing system capable of running an HTML compliant Web browser such as Microsoft's Internet Explorer, Netscape Navigator, Lynx and Mosaic. A typical system that is used is a personal computer with an operating system such as Windows 95, 98, 2000, XP or ME or Linus, running a Web browser. The exact hardware configuration of computer used by the Users 10, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

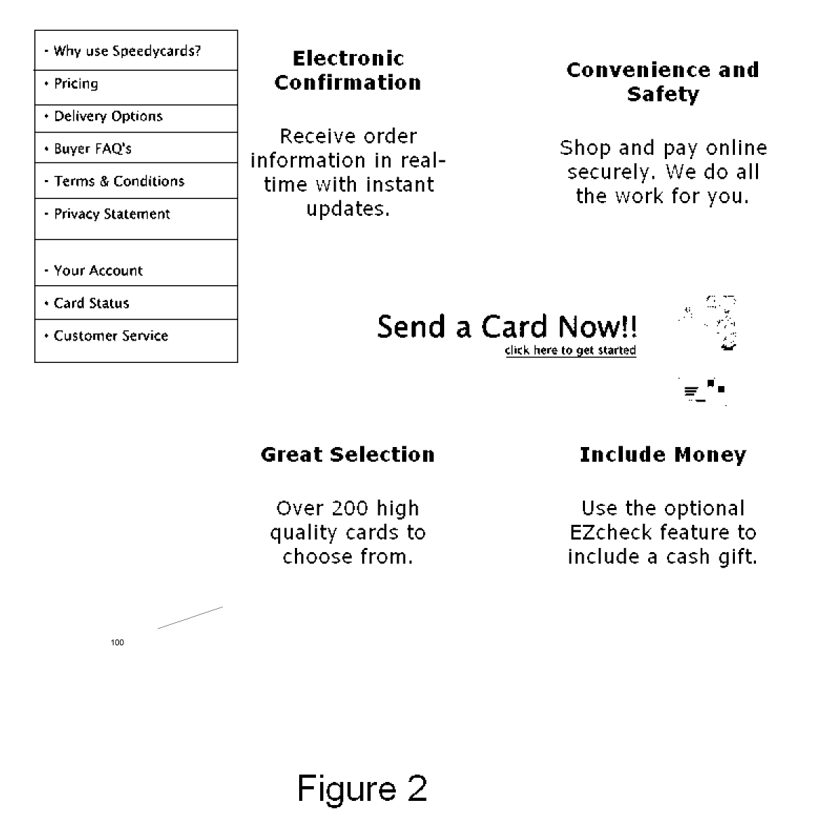

In one preferred embodiment of the invention, the Users 10 connect to the Web site 100. The system 1 would have a standard home web page 200 as shown in FIG. 2. This home web page 200 would have information about the system 1 such as electronic confirmation, convenience and safety, selection of card and the including of monetary gifts. There would be a hypertext link to begin the process of selecting and sending a card. This would be described as “Send a Card Now!!” as shown in FIG. 2. The home web page 200 would have hypertext to other specialized web pages. In the preferred embodiment, these would be: why use the process, Pricing, Delivery Options, Buyer FAQ's, Terms and Conditions, Privacy Statement, Account, Card Status and Customer Service.

The web site 100 would have a standard FAQ web page. This technology is also well known in the art.

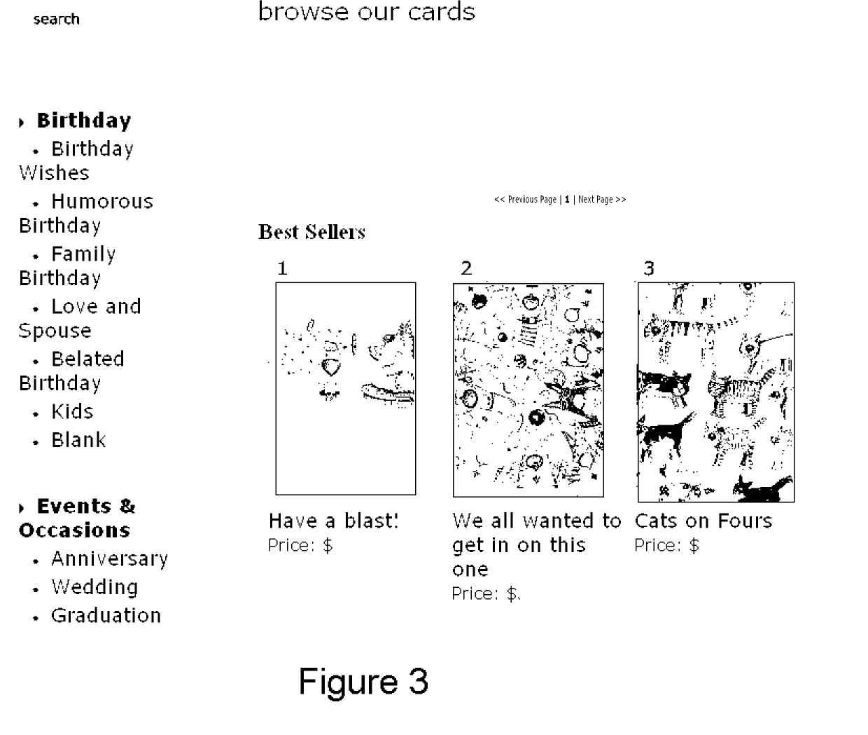

After hitting the hyperlink to send a card now the User 10 will select a card 30. A sample card selection screen 300 is shown in FIG. 3. The User 10 can select a card from the best sellers or from one of a number of special events. The card screen 300 will have hyperlinks to cards 20 for each of the special events. These hyperlinks are on the left side of the card screen 300. These special events can include; Birthdays with cards 30 for birthday wishes, humorous, family, love and spouse, belated, kids and blanks; Events and Occasions such as anniversary, wedding, graduation, baby showers, bridal showers, baptism and quick greetings; Congratulations on things like retirements, announcements and religious; Get well cards that are funny, religious and blank; Miss You and Friendship cards; and Holiday cards for Christmas, Halloween, Easter, Valentine's Days or any other holiday. Each type of card screen 300 can have more cards that User 10 can choose from by moving from one screen to another using a hyperlink forward and back function.

The card screen 300 will display a number of cards 30 for a user 10 to choose from. When a User 10 chooses a card 30, the user 10 must place the mouse cursor over the card that they want to send and clink the select button on the mouse or optical selection device.

After choosing the card 30, the user 10 will be taken to the card input screen 400. The card input screen 400 will allow the user 10 to customize & send the card 30. The user 10 will be allowed to enter a personal message in a text input box. This personal message will appear at the bottom of the inside left hand side of the card. The user 10 can enter a maximum of 320 characters on a maximum of 8 lines. The user 10 can select a font and color for the message. The user 10 adds a signature. The user 10 will also input a mail date. This is the date that the card 30 will be mailed on.

The user 10 will be able to preview the card 30 before it is sent. The user 10 will have the option of choosing to send a monetary gift such as a cashier's check or Echeck with the card 30 to the recipient 40.

In the preferred embodiment, the system's 1 service will be offered at a low price which will include the greeting card you select with matching envelope, a custom printed message from you inside, and mailed with first class postage.

The system 1 will offer a service to send a monetary payment in the form of a cashier's check oran EZcheck for an additional fee. The monetary payment is made out to the card recipient 40 and can be cashed at any bank just as any personal check. The User 10 will receive confirmation via e-mail when the check is cashed and the order details will be updated. After 60 days the monetary payment will automatically be canceled and will be credited to the user 10 accordingly.

The system 1 will allow different delivery options such as First Class mail with upgrades to the delivery options such as the card 30 can be sent to the recipient 40 via Priority Mail, 2 Day Air, or Overnight Air. The system 1 would use UPS for air deliveries and tracking numbers are provided instantly upon mailing. In the preferred embodiment, orders placed before 3 p.m. may be mailed the same day. All other orders mail the following day excluding Sunday and federal holidays.

The system 1 will create an account for a user 10 after placing the user's 10 first order. The account information will store order details, information such as mailing address and payment details, and addresses of recipients in an address book feature. A user 10 can make changes to their account information through a “Your Account” web page section of the website 100. The account information will be stored on the system's 1 database. The system's database will store also store all of information about both the historical orders and orders in progress made by the user 10. The database will be located on a standard memory means such as a magnetic disk or tape or even on CD/ROMs or DVDs.

The system 1 will print the users 10 return address on the card envelope. In the preferred embodiment, all printing and customization on the cards 30 and their envelopes are done with high end color laser and label printers.

The system 1 will allow the user to pre-schedule or change the mailing date of a card. It may be mailed sameday or a day in the future. If the order has already been placed, the user 10 can go to “Your Account”, click on the “Order Details” of an order, and click “Change Mailing Date”. The user 10 can also cancel the card order if they change their mind, but only if the card 30 has not been mailed or entered a “Preparing for Mailing” status. The user 10 can check on the card status by entering their Top of FormOrder/Card Number to find the real time status. To update or view all order details the user 10 must log into “Your Account”.

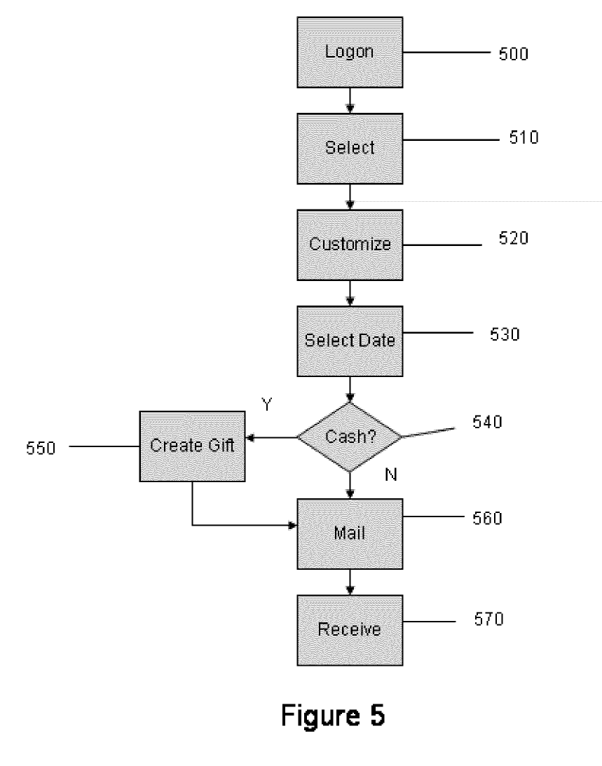

The main process of the system 1 is shown in FIG. 5. In the first step 500, the user 10 logs on to the website 100. The user 10 then selects a card 30 in step 510. The user 10 then customizes the card 30 by adding customized text and a signature, step 520. The user 10 selects a mailing date, step 530. The system 10 then asks if the user 10 wants to send a monetary gift, step 540. If yes, create gift, step 550. The system 1 then creates the card 30 and mails it, step 560. The recipient 20 then receives the card 30, step 570.

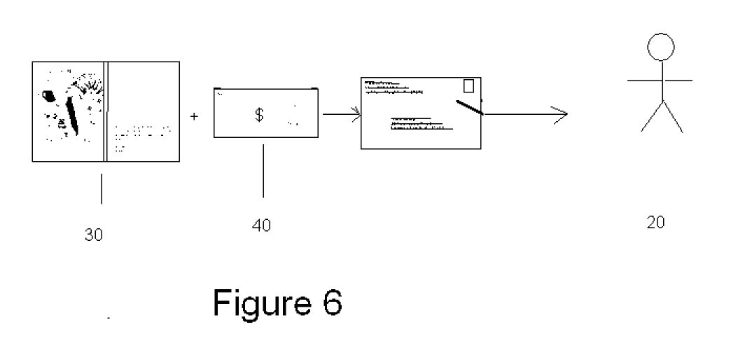

FIG. 6 displays the flow of the card 30. The card 30 is created. The monetary gift 40 is created if it was ordered. The card 30 and gift 40 are mailed and received by the recipient 20.

The System 1 will be written using programming languages, techniques and knowledge that are commonly known in the art.

Although the present invention has been described in considerable detail with reference to certain preferred versions thereof, other versions are possible. For example, the web site could use a different or new protocol to communicate or an Intranet could be used. Therefore, the point and scope of the appended claims should not be limited to the description of the preferred versions contained herein.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A system for a user to send a greeting card comprising: having a user connect to a card system; having said user select a greeting card; having said user write a text message printing send card; printing send message on said card and sending said card.

2. A system according to claim 1 which includes having said user send a monetary gift.

3. A system according to claim 1 which includes having said user being allowed to select the font of said message.

4. A system according to claim 1 which includes having said user being allowed to select the color of said message.

5. A system according to claim 1 which includes having said user contact the system through the Internet.

6. A system according to claim 1 which includes having said user connect to the system through the use of a computer.

7. A system according to claim 1 which includes having said user connects to the system through the use of a computer through the internet.

8. A system according to claim 1 which includes having a status of whether the card has been sent.

9. A system according to claim 1 which includes having an account for each user.

10. A system according to claim 1 which includes sending said cards to the recipient using a postal service.

11. A system according to claim 1 which includes having said user“s address as the return address.

12. A system according to claim 1 which includes allowing said user to send said card on a given date.

13. A system according to claim 12 which includes allowing said user to change said date.

14. A system according to claim 1 which includes allowing said user to choose the method of postage.

15. A system according to claim 1 which includes having said cards for specific events.

16. A system according to claim 15 in which said events are holidays.

17. A system according to claim 15 in which said events are congratulations.

18. A system according to claim 1 which includes having said cards are get well cards.

19. A system according to claim 1 which includes having said cards for birthdays.

20. A system according to claim 1 which includes having said message appear at the bottom of the inside left hand side of said card.
